(19) United States
(12) Patent Application Publication
(10) Pub. No.: US 2014/0210763 A1
(43) Pub. Date: Jul. 31, 2014

(54) TOUCH SCREEN IMAGING SENSOR

(71) Applicant: RAYTHEON BBN TECHNOLOGIES CORP., Cambridge, MA (US)

(72) Inventors: Stuart W. Wells, San Francisco, CA (US); Alden W. Jaclson, Brookline, MA (US)

(73) Assignee: RAYTHEON BBN TECHNOLOGIES CORP., Cambridge, MA (US)

(21) Appl. No.: 13/750,501

(22) Filed: Jan. 25, 2013

(51) Int. Cl. G06F 3/041

(52) U.S. Cl. CPC G06F 3/0412
USPC 345/174

(57) ABSTRACT

Provided are systems and methods for detecting and associating location information with changes in capacitance on a capacitance sensor assembly of a computing device. Enhancing capacitance detection to include location information can enable generation of image data for display to user showing properties of a concealed object. Rates of change in capacitance drain detected at the sensor assembly coupled with location information can be stored in a derivative image format. The derivative image format of a concealed object can be transformed into an approximation of a conventional camera image. Further processing can be executed to define properties of the concealed object, and identify the concealed object. Further processing can also include model-based analysis and/or property matching to known objects. Image displays can also be correlated to subsequent positions of the device, allowing “x-ray” views of concealed objects

### BACKGROUND

Touch screens on various computing devices are conventionally used to provide for user interaction with a computing device. The touch screen and associated sensors allow a user to activate the device with a touch, control computer functions with a swipe of a finger, zoom in/out, and generally interact with content on the device simply by touching the display screen.

For example, some ANDROID based devices, IPHONE, and conventional tablets use touch screens, and in particular, capacitance-based touch screens to determine when a user has touched the display. The capacitance-based touch screens are configured to provide a capacitance that forms a lattice across the surface of the touch screen display. When a user touches the screen, the proximity and/or contact with the user's finger, for example, drains the capacitance in the touched region. The charge associated with the capacitance can be continually measured by sensors while the device is in operation. Any detected capacitance changes can be located on the screen and correlated with, for example, a user touching the screen, swiping a finger across the screen, among other options. Logic executing on the device can interpret those touches into computer functions.

Capacitance sensing systems in touch screens are known. Some other conventional capacitance sensing systems have been used to detect hidden objects based on changes in capacitance when the capacitance sensors are placed proximate to hidden objects. However, known systems can be bulky and provide little more information than a signal that a change in capacitance has occurred.

Other approaches have used additional sensors in personal computing devices and customized applications to provide for detection of hidden objects. As is known, smart phone devices can be augmented by customized applications or “apps” to provide additional functionality. In one example, sensors (including e.g., a magnetometer) in the device are used to detect proximity to metallic objects. Using signals from the sensors on a portable device, a “stud finder app” can enable an IPHONE to detect nails or screws and infer the presence of a beam concealed within a wall. In one example, as the user draws their IPHONE across the wall, proximity to metal objects is detected and used to trigger visual or audible alarms to alert the user to the possible presence of a beam.

### SUMMARY

It is realized that personal computing devices that include capacitance-based touch screens can be augmented to detect concealed dense or metallic objects by passing the touch screen over a concealing surface. In some embodiments, a personal computing device can be modified to detect concealed objects by sensing changes in capacitance detected at the touch screen. It is also realized that by capturing positional information along with changes in the capacitance, the personal computing devices can generate probable or approximate images of a concealed object based on the detected changes in capacitance. Any “approximate image” reflects an approximation of the image of the concealed object as would be captured by a conventional camera if the object were not concealed. The images can reflect, for example, concealed beams detected in a wall, wires, plumbing, etc. Further processing of the image data can also provide the ability to generate refined visualizations of concealed objects, and further refinements of the image including, for example, object identification. Object identification can include model-based analysis, where detected changes are compared to models of changes for known objects. Depending upon the environment in which the device is deployed, concealed object detection can include identification and visualization of weapons in luggage, as well as objects concealed in a wall, or other objects concealed from line of sight.

According to various aspects, provided are systems and methods for detecting and associating location information with changes in capacitance of a capacitance sensor assembly on a computing device. Enhancing capacitance detection, for example, to include location information can enable generation of image data for display to user showing properties of a concealed object. In one embodiment, capacitance and location information is combined to generate derivative image data. Derivative images can be generated by taking conventional image data (e.g., data representing a digital photo) and performing a derivative mathematical operation on the data. The output of the derivative operation represents the image as rates of changes in intensity of pixel values according to distance in the x and y directions.

According to one embodiment, rates of change in capacitance drain detected at the sensor assembly can be stored combined in a similar manner with location information to provide a derivative image format. The derivative image format of a concealed object can then be transformed into an approximation of a conventional camera image (e.g., taken by a digital camera if the object were not concealed), for example, by performing the reverse of the derivative operation. Further processing can be executed to define properties of the concealed object, and to identify the concealed object. Further processing can include model-based analysis and/or property matching to known objects. Images displays can be correlated to subsequent positions of the device, allowing “x-ray” views of concealed objects showing images of objects as they appear behind a concealing surface.

According to one embodiment, a change in capacitance can be recorded, for example, as a user transitions a touch screen of a computing device across a surface. Location sensors (e.g., an accelerometer or gyroscope) within the device can capture location information as the capacitance changes at the touch screen are measured and recorded. Combining changes in capacitance with changes in location information can be stored, for example, as raw image data of a derivative image format showing a mapping of the rate of capacitance change with respect to position (also known as a density gradient—an example of a derivative image format). If, for example, changes in rate of drain in capacitance are recorded as intensity values and combined with location information, a gradient generated from those values is a vector, whose components measure how rapidly the intensity values are changing with distance in the x and y directions. An example gradient image displays the gradient vectors, for example, as dark and light bands.

The raw sensor/image data can be presented as a raw image or be manipulated to produce a processed image of what has been detected. The raw data can be saved in different formats, including a density gradient, or other mappings of capacitance and position. In some embodiments, the image data is used to generate a probable or approximate image of a concealed object in response to the collection of capacitance data and location information.

According to one example, metal objects can be hidden or obscured by a surface or other materials and objects. Metal and/or dense objects trigger a faster drain of capacitance on a capacitance-based touch screen. As the increased drain causes the capacitance measurements to change as the device is maneuvered over a concealed metal object, the shape and rough edge details of the object can be determined, for example, using captured location information. Alternatively, if the touch screen position is known for capacitance measurements (e.g., the device is moved along a known path over a surface), the device can produce an image of a concealed object detected without needing location sensors. In some embodiments, location information can be derived from the predetermined path and associated with capacitance data.

According to one aspect, a system for detecting concealed objects is provided. The system comprises at least one capacitance sensor integrated in a hand-held computing device, at least one processor configured to access location information for the hand-held computing device, correlate capacitance data received from the at least one capacitance sensor with the location information, and a display configured to render an image representing a concealed object from the correlated capacitance data and location information.

According to one embodiment, the system further comprises at least one location sensor in the hand-held computing device. According to one embodiment, the at least one processor is further configured to generate the location information for the hand-held computing device responsive to sensor data received from the at least one location sensor. According to one embodiment, the at least one location sensor includes at least one accelerometer, and the at least one processor is further configured to generate the location information from measurements of acceleration by the at least one accelerometer of the hand-held computing device. According to one embodiment, the at least one processor is further configured to generate the location information from a predefined path of travel for the hand-held computing device.

According to one embodiment, the at least one processor is further configured to generate image data for the concealed object from correlating the capacitance data and the location information. According to one embodiment, the at least one processor is further configured to execute an integral operation on the image data to transform the image data from a derivative format to an approximate image format of the concealed object. According to one embodiment, the at least one processor is further configured to identify concealed objects detected with the correlated capacitance data and location information. According to one embodiment, the at least one processor is further configured to compare the correlated capacitance data and the location information to known models of concealed objects to identify concealed objects.

According to one embodiment, the at least one processor is further configured to determine subsequent location information for the hand-held device; and select a portion of an image of the concealed object to display, responsive to the subsequent location.

According to one aspect, a computer implemented method for detecting concealed objects is provided. The method comprises acts of positioning at least one capacitance sensor of a computing device on a concealing surface, capturing, by at least one processor, capacitance data from the at least one sensor while transitioning the computing device across the concealing surface, generating, by the at least one processor, image data associated with a concealed object from the capacitance data and location information for the computing device.

According to one embodiment, the method further comprises an act of capturing, by the at least one processor, location information from at least one location sensor in the computing device. According to one embodiment, the method further comprises an act of generating, by the at least one processor, the location information for the computing device responsive to the act of capturing the location information from the at least one sensor. According to one embodiment, the at least one location sensor includes at least one accelerometer, and wherein the act of generating the location information includes an act of generating location information from measurements of acceleration by the at least one accelerometer.

According to one embodiment, the method further comprises an act of generating, by the at least one processor, the location information from a predefined path of travel for the computing device. According to one embodiment, the act of generating, by the at least one processor, image data associated with a concealed object includes an act of correlating the capacitance data and the location information. According to one embodiment, the method further comprises an act of transforming, by the at least one processor, the image data from a derivative image format to an approximate image format of the concealed object.

According to one embodiment, the method further comprises an act of identifying, by the at least one processor, concealed objects based, at least in part, on the correlated capacitance data and location information. According to one embodiment, the act of identifying includes an act of comparing the correlated capacitance data and the location information to known models of concealed objects. According to one embodiment, the act identifying includes an act of deriving properties for the concealed object based, at least in part, the correlated capacitance data and the location information. According to one embodiment, the act of identifying includes an act of comparing the derived properties to properties of known objects.

According to one embodiment, the method further comprises acts of determining subsequent location information for the device; and selecting a portion of an image of the concealed object to display, responsive to the subsequent location.

### BRIEF DESCRIPTION OF THE DRAWINGS

Various aspects of at least one embodiment are discussed below with reference to the accompanying figures, which are not intended to be drawn to scale. In the figures, each identical or nearly identical component that is illustrated in various figures is represented by a like numeral. For purposes of clarity, not every component may be labeled in every figure. The figures are provided for the purposes of illustration and explanation and are not intended as a definition of the limits of the invention. In the figures:

FIG. 1 is a block diagram of an example system for detecting concealed objects from capacitance measurements;

FIG. 2 is a flow diagram of an example process for detecting change in capacitance and positional information for the changes in capacitance;

FIGS. 3A-D are conceptual illustrations of approaches for detecting concealed objects using a hand-held computing device;

FIG. 4 is a flow diagram of an example process for associating location information with detected changes in capacitance;

FIG. 5 is a flow diagram of an example process for generating display images of concealed objects;

FIG. 6 is a flow diagram of an example process for identifying concealed objects; and

FIG. 7 is a block diagram of one example of a computer system that may be used to perform processes and functions disclosed herein.

### DETAILED DESCRIPTION

Conventional personal computing devices provide convenient and mobile sensing and processing platforms. According to some embodiments, using sensors already available on such devices, these computing devices can be modified or re-purposed for detection of concealed objects. In typical implementations, concealed objects include objects that cannot be readily visualized by the human eye, including those objects that are behind or within another structure or object.

According to one example, a system for detecting concealed objects can include a hand held computing device having a capacitance-based touch screen modified to detect concealed objects through measurements of capacitance at the touch screen. The device can be specially configured to enable a user to draw the device over a surface and record changes in capacitance. From the measurements of the changes in capacitance, image data can be generated. In some embodiments, location information is associated with the measurement of the changes in capacitance. Through processing of the position and capacitance data, a variety of images can be formed. In one example, the generated image represents the rates of change or gradient density for capacitance and position detected by the device. An image of the gradient density can be displayed to the user, enabling visual identification of concealed object. In some embodiments, the system executes image processing to automatically identify and, for example, label objects within the gradient image. Further image processing can include generation of color images with or without object labels, for display to a user. In some embodiments, the image data can also be processed to identify the concealed object or compare captured data to data to models of known objects.

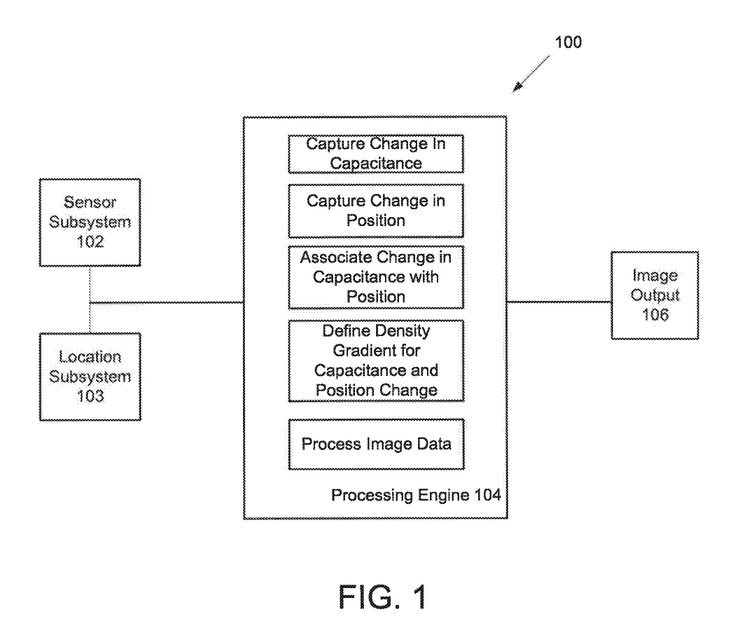

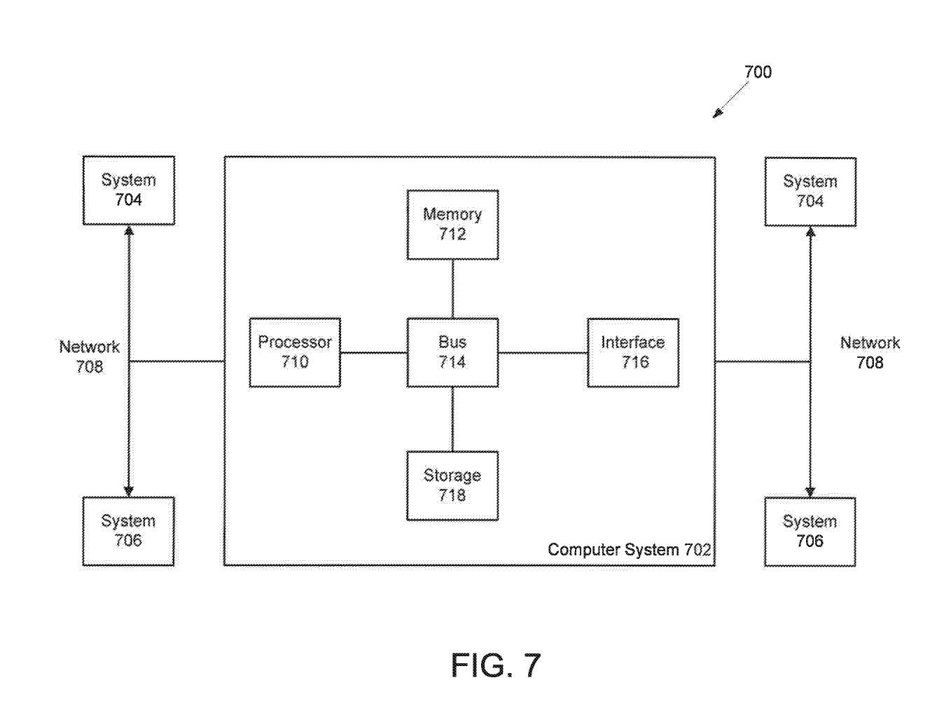

Referring to FIG. 1, there is illustrated one example of a system 100 for detecting concealed objects using a processing engine 104. Elements of the system 100 can be provided using a computing system such as the computer system 700 and/or 702 described with reference to FIG. 7, which can include, for example, personal computing devices such as an IPHONE or an ANDROID based personal computing device.

Shown in FIG. 1 is a block diagram of an example system 100 for detecting concealed objects. System 100 can be implemented on a personal computing device (including e.g., an IPHONE or ANDROID device) locally executing the processing engine 104. In some embodiments, the system 100 can be implemented on a personal computing device networked to server system(s) to provide for additional processing of captured data. The functions of the processing engine 104 can be distributed between the personal computing device and the server(s).

In some embodiments, changes in capacitance can be detected and used to identify the concealed object by moving the personal computing device over a surface concealing the object. In one example, the system 100 receives capacitance data from capacitance subsystems 102 on the personal computing device. The capacitance subsystems 102 can be integrated in personal computing devices as part of touch screen components. The personal computing device can be configured to execute the processing engine to generate images from the capacitance data. In another embodiment, the personal computing device can communicate information from capacitance subsystems 102 to server(s) over a communication network (not shown) to execute at least some of the image processing functions of the processing engine 104.

According to one embodiment, the personal computing device includes a capacitance-based touch screen and capacitance sensors. The capacitance sensors can be included in the capacitance subsystem 102. Any changes in capacitance at the touch screen can be detected by the capacitance sensors. The personal computing device can also include location subsystems 103 configured to capture location information (e.g., distance, speed, velocity, position, position on a surface, relative position, among other options) for the device in conjunction with changes in capacitance. Location subsystems 103 can include location sensors integrated on the personal computing device (including e.g., an accelerometer, GPS, gyroscope, and magnetometer) and can, in some examples, include apps configured to produce location information for the device. The processing engine 104 can be configured to correlate capacitance changes and changes in position received from subsystems 102 and 103 to generate image data, for example, to display a gradient density (i.e. rate of changes) detected by the capacitance and location sensors.

The processing engine 104 can also be configured to combine all the data (e.g., capacitance and location information), and generate a gradient density image representing the rates of change of capacity and position. The gradient density image can be displayed to a user of the personal computing device and/or system 100 as an output 106 of the system 100.

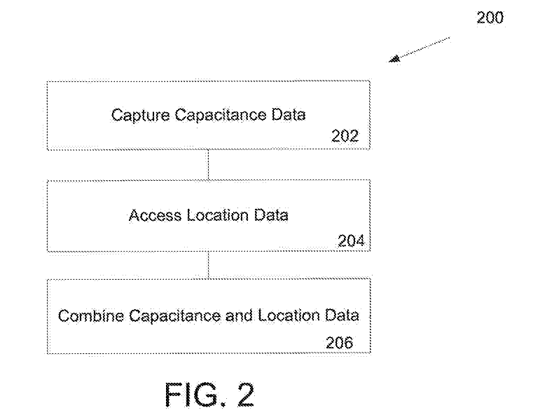

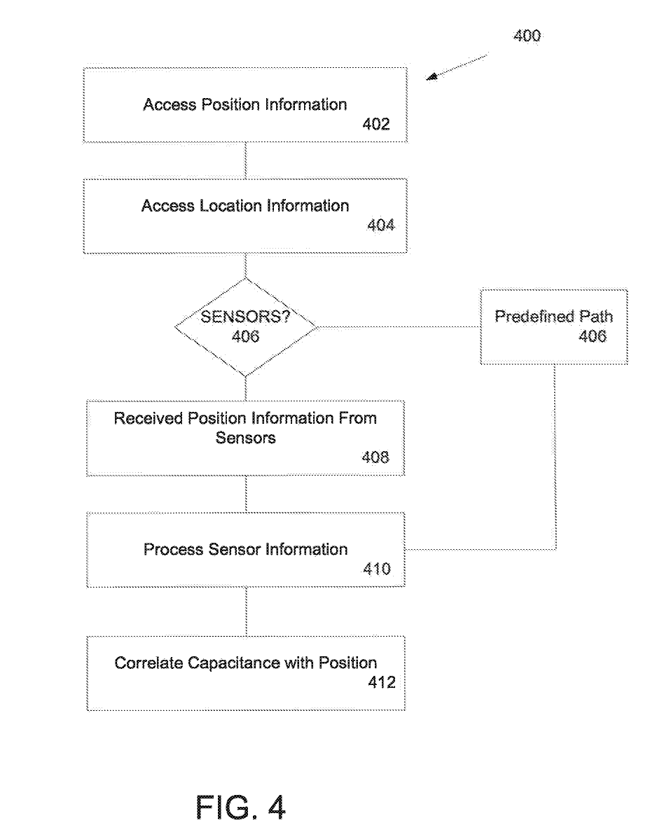

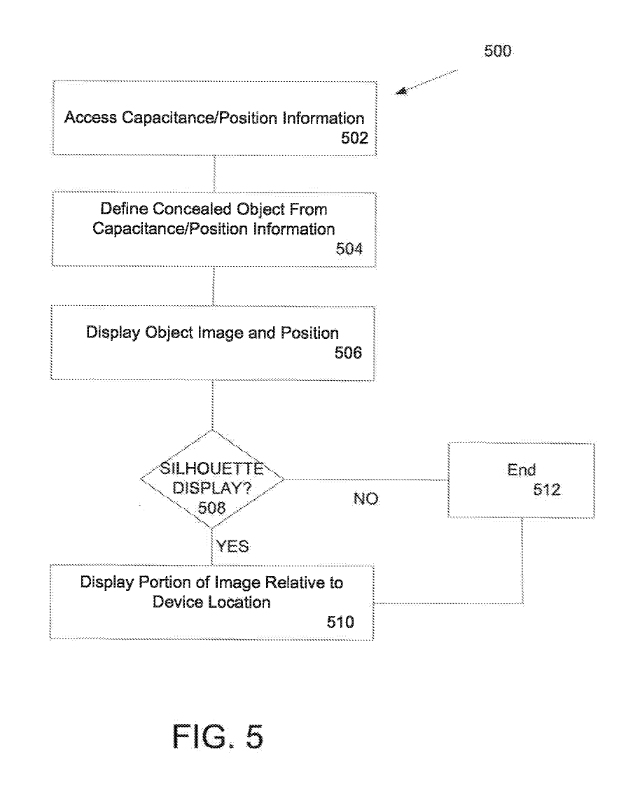

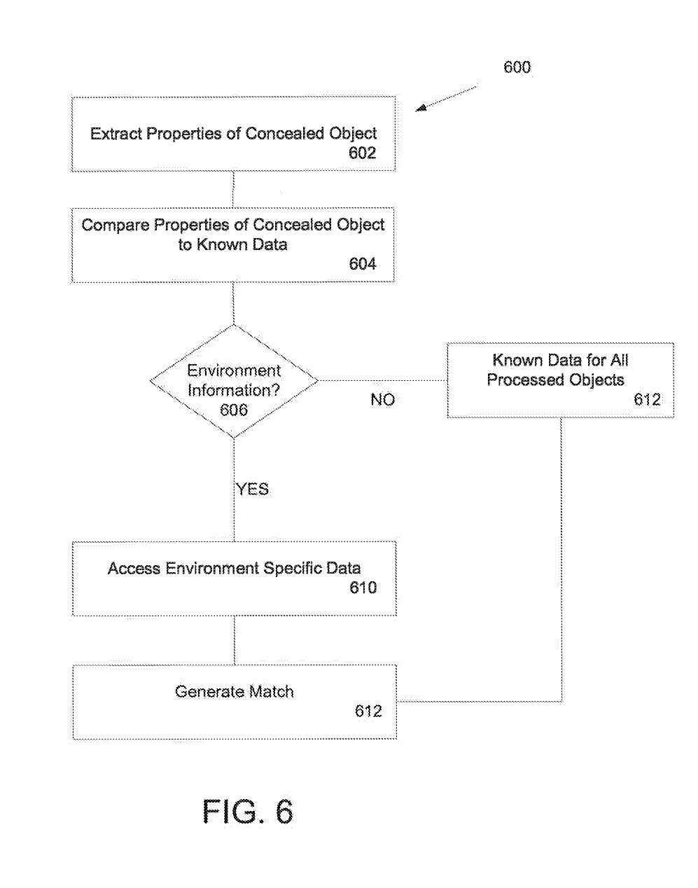

According to various embodiments, the processing engine 104 can be configured to execute one or more processes to monitor and/or record changes in capacitance at a touch screen (e.g., process 200, FIG. 2). Processing engine 104 can also be configured to execute additional processes to associate location information with changes in capacitance (including e.g., process 400, FIG. 4). The processing engine 104 can be configured to display the raw sensor data, and/or combine the sensor data into a derivative image for display. Further processes executed by the processing engine 104 can analyze capacitance and location data to generate images of concealed objects (e.g., process 500, FIG. 5) or compare captured capacitance/location data to data for known objects to identify the concealed objects (e.g., process 600, FIG. 6).

In some embodiments, processing engine 104, can also correlate image data to a new current position of the personal computing device. Stated broadly, once capacitance information is captured and processed with location information, the operator can reposition the personal computing device with the display oriented towards the user to allow the operator “look through” a concealing surface by visualizing a portion of the processed data corresponding to the current position of the personal computing device.

Processing engine 104 can be executed to display an image (derivative or processed) of any concealed object appearing at the device's current position. The processing engine 104 can also be configured to transition the position of the displayed image as the device moves along the concealing surface. In one example, the processing engine 104 is configured to display an image of a pipe within a wall using the device's current location. As the user slides the device along the wall, the processing engine 104 is configured to display the image of the pipe relative to its position in the wall as the device moves using location information from the device's location sensors to transition the display.

As discussed above, system 100 and/or processing engine 104 can execute a variety of processes to capture and process capacitance and position data. FIG. 2 shows one example of a process 200 of detecting and/or capturing capacitance information. Process 200 can be executed to detect concealed objects, for example, using computer systems described below with reference to FIG. 7 (e.g., system 700 and/or 702). Process 200 includes steps of detecting changes in capacitance generated at a touch screen using capacitance sensors, where the changes in capacitance are monitored by the sensors while the touch screen is moved across a surface that obscures an object from view, associating changes in capacitance with location information (e.g., distance, speed, velocity, position, among other options), combining and storing the change in capacitance with an associated change in position, and, can optionally include, generating images of detected objects from the capacitance and location information, and displaying concealed objects on a display screen of a computing device.

Process 200 can be instantiated, for example, by a processing engine (e.g., 104) executing on a personal computing device having a capacitance-based touch screen. In one example, an operator can trigger an application on the device to begin execution of the processing engine, process 200, or to generate a signal to an already executing processing engine to begin process 200, including storing and/or processing capacitance data provided by capacitance sensing subsystems.

In one embodiment, process 200 beings at 202 with capture of capacitance data communicated by capacitance sensors on a touch screen. As discussed above, sensor subsystems integrated on a personal computing device (including e.g., an IPHONE or ANDROID device) can include capacitance sensors. In one example, at step 202, the processing engine receives capacitance information detected by the capacitance subsystems as the device is drawn along a surface concealing object(s) from view. Depending on the environment in which process 200 is executed, the surface could be a wall of a building, a container, luggage, etc.

At step 204, location information for the device is accessed and combined with the capacitance data at 206. In some embodiments, the location information for the device is communicated from location subsystems. The location subsystems can include locations sensors, which can be any one or more of accelerometers, gyroscopes, magnetometers, GPS sensors, among other examples. At 204, location information can be accessed as the device is drawn along the surface. In some embodiments, location information can also be determined from a predefined path. For example, process 200 can include an act of determining location information from a predefined path. The predefined path can establish, for example, any one or more of a distance to travel over a surface, a speed of travel the user should maintain, a path of travel over the surface, etc. The determined location information can then be accessed at 204 and combined with capacitance data from 202 as a function of the position of the device along predefined path at 206.

The data can be combined in a variety of formats at 206. In one embodiment, the capacitance data from 202 and the location information from 204 can be combined at 206 to generate a Gaussian image of any concealed object(s). Conceptually, the Gaussian image obtained from the capacitance information and the location information is the first derivative of conventional image information that would be captured in a traditional reflected light image. The Gaussian image is an example of a derivative image format. Thus, generating the integral (i.e., inverse of a derivative operation) of the Gaussian image data produces a probable or approximate image of any concealed object, where the probable or approximate image approximately reflects the image that would be seen if the object were not concealed.

In some embodiments, capacitance data can be augmented by data from other sensors. For example, for a computing device that includes a magnetometer, execution of process 200 can also include recording of capacitance and magnetometer information to define the Gaussian image data. In some other embodiments, image data may also be captured using just the magnetometer and location information. The data provided by the magnetometer can be combined with location information to generate image data, and the image data processed to define an approximate image of a concealed object. Similar to processing of capacitance image data, image data generated from magnetometers can be analyzed using object models to refine the identification and image generation of a concealed object.

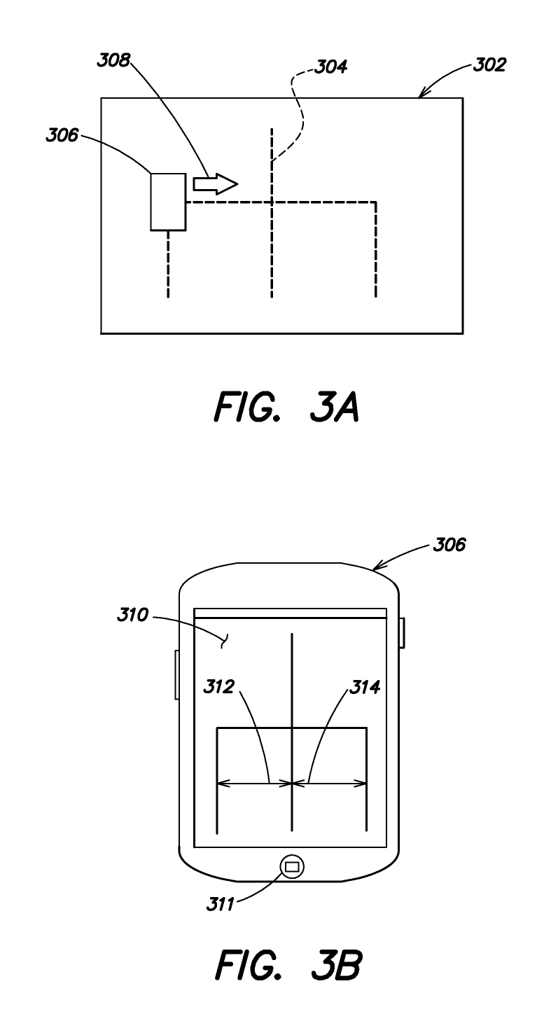

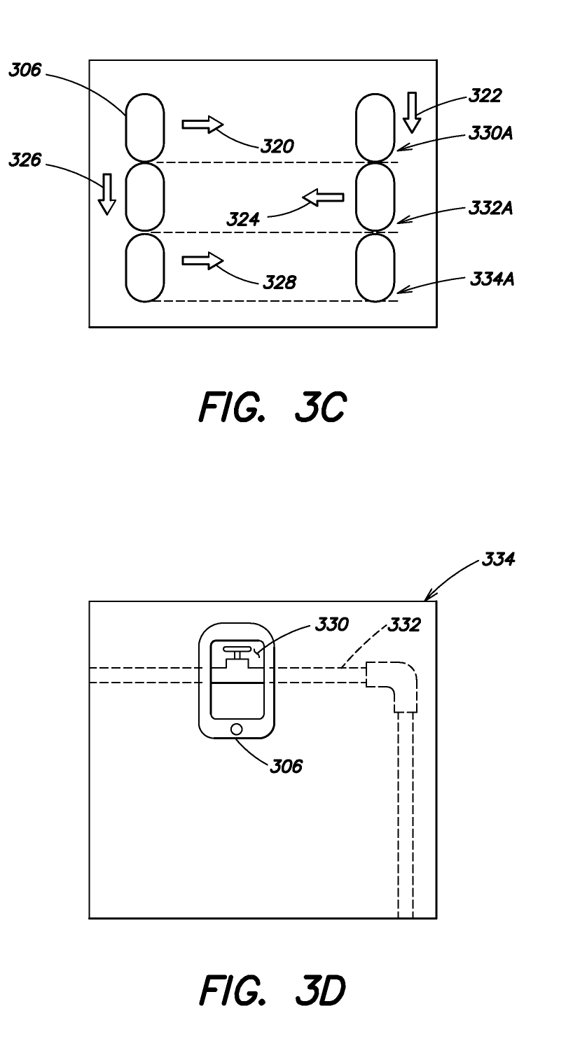

Referring to FIGS. 3A and 3B, shown are a schematic flow for detecting and imaging concealed objects and an output image displayed using a personal computing device 306 (e.g., an IPHONE). Shown in FIG. 3A is a surface 302, for example a wall concealing wires at 304. A user transitions the device 306 across the wall 302, shown by arrow 308, and the device records changes in capacitance and changes in position as the device is moved. For example, the device can be configured to detect the movement and relative position of the touch screen using an accelerometer and/or gyroscope contained in the device. In some embodiments, the changes in capacitance values can be recorded in response to detection of the movement of the device.

In other embodiments, the user activates the device to capture capacitance information by starting an application. Once the application is running, the user transitions the device across the wall 302. The user may be instructed, for example, by the application to transition the device laterally (320, FIG. 3C), then downwards (322), followed by a sweep back (324), which motions can be repeated (e.g., at 326 and 328), until the device is transitioned across adjacent portions (e.g., 330, 332, and 334) of the surface the user wishes to process. In one example, the user can indicate the process for capturing information is complete in a user interface displayed on the device. In other examples, a physical button on the device (e.g., 311, FIG. 3B) can be actuated to indicate the capture task is complete. Once data capture is complete, the information can be processed and/or integrated to generate a probable or approximate image for display. The generated image can be configured to show any object or objects under the surface 302 and estimated dimensions for the object (e.g., 310 FIG. 3B).

Shown in FIG. 3B is the device 306, and an output image 310 generated from the captured data. At 312 and 314 approximate dimensions for the concealed object are illustrated. In other examples, any determined dimension can be displayed. In one implementation (not shown), the device can be configured to display additional dimensions (width of a wire, pipe, etc.) in response to a zoom in operation performed on the display. In further embodiments, the determined properties for a concealed object (e.g., positions of edges, length, width, contour, etc.) can be used to label the object in the display. For example, based on matching approximate dimension information to dimension information for known objects stored in an objects database, the display can be labeled conduit, wire, pipe, etc. In other examples, matching can be generated based on captures capacitance/location information matches against capacitance/location information for known objects.

According to one embodiment, once the user finishes capturing the data, the resulting image represents the changes in the capacitance gradient induced by the hidden objects beneath the concealing surface. Large rates of change can be used to define and/or highlight edges of concealed objects in the resulting image. According to one aspect, because the surface itself causes capacitance to drain at the touch screen, a change in the rate of drain of capacitance is used to identify the first edge of a dense or metal concealed object behind the surface. Accordingly, in some examples, the next large change in rate of drain can be used to detect a second edge of a vertical beam (assuming the device is moving laterally) or any other dense or metal concealed object. An approximate image of a concealed object can be then be generated from the data or a gradient image. In one embodiment, the device is configured to determine a center of any detected capacitance change, and follow the contours of the object (including e.g., detected edges) to create a silhouette or outline of the object that is below the concealing surface. The detected silhouette or outline can be displayed as an image on the device.

In some embodiments, the generated image can also be enhanced, for example, in terms of resulting image quality, using object models. In one embodiment, matching of raw data, a generated image, and/or gradient data can be executed by the system against model data for known objects. Based on a detected match or a degree of matching, the system can identify specific objects. In some implementations, domain specific information (e.g., where the data capture is taking place) can be used to select models and model data for specific objects typically found in the domain. When detecting objects behind a wall in a house, for example, model data for plumbing, wiring, beams, etc., can be analyzed to determine matches. In a security setting, model data for weapons can be analyzed, as well as model data for more conventional items (e.g., toothbrush, curling iron, etc.).

According to various embodiments, applications can be provided on IPHONEs that execute processes to detect concealed objects. FIG. 4 illustrates an example process 400 for associating location information with detected changes in capacitance that could be executed on a personal computing device, including an IPHONE. Process 400 begins at 402 with accessing detected changes in capacitance. In some embodiments, detected changes in capacitance can be recorded by separate processes and/or separate sensor systems, and the recorded data can be accessed during execution of process 400. In other embodiments, capacitance data can be captured as part of 402 or delivered directly to an application executing process 400 at 402.

At 404, process 400 accesses location information at 404 to correlate changes in capacitance and the location information at 412. According to one embodiment, how process 400 correlates changes in capacitance and location information can be dependent on the source of location information. At 406 YES location information for the device is accessed directly from location sensors or a memory recording information from the sensors on a device executing process 400 at 408.

At 408 NO, location information for the device is determined from a predefined path at 414. The predefined path can include delimited boundaries for imaging concealed objects. For example, the predefined path can include a lateral move of 6 feet, followed by a transition down the wall based on the height of the capturing device, with another lateral move in the opposite direction of 6 feet. The user can be instructed to repeat such a path until the user has transitioned the device over any portion of the surface that the user wishes to be processed. In some embodiments, the predefined path can specify a speed at which the user is to move the device. The device can then generate location information from the predefined path and associate capacitance information (e.g., at 412). In some embodiments, a personal computing device can be configured to display the predefined path as part of a data capture application. The application can also include “training,” enabling the user to follow the path in training runs with feedback (e.g., audible, visual, tactile, etc.) based on their ability to follow the predefined path.

In other embodiments, sensors integrated in the device can be used to provide the location information for the device (e.g., 406 YES and 408). Location information for the device can be obtained from location sensors at 408. For example, speed and movement information can be provided by an accelerometer. Magnetometers can also provide information on relative position of a device. GPS systems can likewise provide location information for the device. In some embodiments, cameras on the device can also be used as location sensors. The cameras can be configured to capture images at the start of a lateral movement and at an end position of the lateral movement. For example, determinations of distances traveled can be executed based on parallax calculation from the captured images. In other examples, distance/position information can be derived from processing video captured during the movement of the device. Some conventional applications can also provide location information. In one example, configuration operation can detect any available location applications and enable, for example, process 400 and/or a processing engine to request/receive location information from such applications.

In some embodiments, location information is processed at 410 to enable correlation of the capacitance data and the location information at 412. For example, location information can be processed to provide a rate of change of position, which can be correlated with a rate of change of capacitance. In other examples, the capacitance data and location information can be correlated at 412, and a Gaussian image of the correlated data can be presented to the user on a display of their device. Further processing of the capacitance and image data can be performed, including generating refined images of concealed objects, generating identification of detected objects, generation of approximate images, etc.

FIG. 5 illustrates an example process 500 for generating display images of concealed objects. Process 500 begins at 502 with accessing capacitance and location data captured by a personal computing device. In some embodiments, step 502 can be executed on the personal computing device that captured the capacitance and location data. In other embodiments, processing can be distributed over multiple computing systems, thus access of the capacitance and location data (step 502) can occur over multiple computing systems which receive the captured data directly or indirectly from the personal computing device.

At 504, properties of concealed objects are defined from the accessed capacitance and location information from 502. In some embodiments, the properties of any detected concealed object can be generated from raw data provided by capacitance sensors. For example, the raw data can provide rates of changes of capacitance drain detected by capacitance sensors. The raw data can also include location information for the device during the capture of the capacitance data. Step 504 can include correlating any changes in rate of capacitance drain detected with the location information, which can include change in position of the device during capture. In some embodiments, the data can be accessed in a processed or correlated form. For example, the capacitance and location data can be correlated by other processes and stored for access by other processes (including, e.g., 500). Further, correlated capacitance/location information can be communicated to other processes to enable access, for example by process 500 at 502. Correlated data can be stored or communicated in a variety of formats, including as an image gradient or a Gaussian image, among other options.

Conventional approaches for object definition in image data can be executed at 504 to define the properties of any concealed object reflected in the capacitance/location data. For example, known edge detection approaches can be used to define the outer boundaries of a concealed object. Image segmentation processing can be executed to define individual objects in the capacitance/location data.

In other embodiments, step 504 can include execution of processes to detect a center of an object from the capacitance/location information, and the contours of the concealed object can be determined by radiating out from the determined center. Object definition can also include definition of positions of edges, length, width, curvature, boundaries, outline, etc., for any concealed object. The determined dimensions of any concealed object or portion of a concealed object can be associated with the image data or the raw sensor data.

In some embodiments, a Gaussian image generated from the combined capacitance/location data is displayed at 506. In some embodiments, further processing of the captured capacitance/location information is executed. For example, the data from the Gaussian image can be integrated to produce an easier to understand representation of a concealed object for display at 506 (an approximate image). In some embodiments, the approximate image displayed at 506 can include any determined dimensions (positions of edges, length, width, curvature, etc.). In further embodiments, the approximate image displayed at 506 can include indicators that enable a user to display dimension of objects responsive to selection in the display.

Process 500 can optionally continue at 508, if, for example, the user selects to view a “silhouette” display. A silhouette display (508 YES) enables the user of a personal computing device to “see through” the concealing surface, by displaying a portion of, for example, the approximate image (e.g., from 506) relative to the device's current position at 510. Execution of step 510 can include a determination of the device's current position relative to a processed surface. Similar to execution of process 200 and the capture of capacitance data, a user positions the device on a concealing surface, however, in a silhouette display, the display screen of the device is oriented away from the surface. As the user transitions the device over the concealing surface, the device is configured to display a portion of any image, where the portion reflects the portion of the image at the device's current position.

FIG. 3D illustrates one example of a silhouette display 330 on a device 306. The display 330 is a portion of an approximate image generated as discussed above. At 332, the remaining portions of the concealed object are shown in dashed line, as concealed object 332 is obscured from view by surface 334. The device is configured to transition the display of the portion of the approximate image as the device is transitioned over the concealing surface. In other embodiments, the device can be configured to display portions of any image that reflect the concealed object at a current position, including, for example, a Gaussian image.

Returning to process 500, the user may select an indicator in the display to terminate the silhouette display at 512. If the user does not engage the optional silhouette view (e.g., 508 NO) or the user elects to terminate the silhouette display, process 500 ends at 512.

As discussed above, a personal computing device can capture, store, and process capacitance and location data to generate a variety of data formats. Any of the recorded data can be transformed into a representative image that reflects rates of change in capacitance measurements against changes in position of the device during the data capture (i.e., derivative image format). In some embodiments, the data can be stored as a Gaussian image of the captured data. Processing of the raw data and/or the generated image data can be executed to identify any objects detected in the captured information.

FIG. 6 illustrates an example process 600 for identifying concealed objects. Process 600 begins at 602 with the extraction of properties defining a concealed object. In some embodiments, property extraction at 602 can be executed by accessing data associated with processed images or image data. As discussed above, various processes executed on a personal computing device can capture and process capacitance data and location information to generate images of concealed objects (e.g., process 500). As discussed above, image generation can include, for example, definition of properties of concealed objects (e.g., position of edges, length, width, contour, boundaries, etc.) which can be stored as part of the image or image data. Extraction at 602 can be reduced to accessing the stored information from a memory location. In further embodiments, the property information can be communicated to a computer system executing process 600, and extraction at 602 can include accessing property information from the received data.

In some embodiments, extracting properties of concealed objects at 602 can include processing of raw sensor data from capacitance and location sensors. For example, extracting data at 602 can include correlating capacitance and location data, as discussed above. In other examples, extracting properties at 602 can also include generating images and executing conventional object detection approaches to define properties of a concealed object. The properties extracted for a concealed object can include height, width, length, boundary, etc., of a concealed object. In further examples, the properties also include the rates of capacitance drain detected for the concealed object.

These properties are compared to known values at 604. In one embodiment, a rate of change of capacitance drain can be associated with at type of material. Based on a comparison of the rate of capacitance drain at 604 a match can be made to a type of material inducing the same rate of change of capacitance drain (e.g., at 612, discussed in greater detail below). In particular, concealed objects made of metal are known to induce a greater rate of drain in a capacitance field than other less dense objects. This property can be used to identify the composition of a concealed object (e.g. metal, wood, plastic, etc.) and can assist in a more specific identification of a detected concealed object.

In some embodiments, the user of a personal computing device can be asked to input environmental information regarding a data capture event. In one example, a user is asked to provide the width of a concealing surface (e.g., drywall of ½″ or ⅝″ is commonly used in a domestic domain). The comparison of properties at 604 can include selection of comparison data at 608 that accounts for provided environmental information 606 (YES). At 610, a match can be generated, for example, based on rates of capacitance drain. The match at 610 can establish a type of material for the objects detected behind a concealing surface.

Other properties can be matched, including object length, width, shape, disposition, etc. In another example, a stud in a wall is typically constructed of “2×4” wooden beams, and typically placed every four feet on center. In actuality, the width of the “2×4” is 1½″, thus an detected object having a width of 1½″ and a long vertical length can be matched to know properties of wall studs. If the same object (i.e., similar capacitance drain and dimension information) is detected at four feet on center, the confidence in the match can be increased. In another setting, weapons have distinct features that can be used to facilitate matches between known capacitance/location information and captured capacitance/location information. In some embodiments, properties detection can include feature identification and/or matching on specific features of known objects (e.g., trigger of a gun, edge of a blade, etc.).

In some embodiment, properties for the concealed object at 602 can include information from a magnetometer. In some personal computing devices, a magnetometer can be used to assist in generation of location information. The intensity of the response generated by the magnetometer when proximate to a concealed object can also be used to identify the material composition of the concealed object. In some embodiments, rate of capacitance drain and/or magnetometer readings can be used during execution of process 600 to further identify a type of metal (e.g., copper, lead, zinc, etc.). In some embodiments, matching at 610 can include a determination of a specific type of metal for a concealed object.

In further embodiments, extraction of properties of the concealed object at 602 can include generation of a model of the concealed object from the extracted properties. Comparison of the properties to known data at 604 can include comparison to known object models. For example, copper piping in housing construction can be analyzed for any one or more of: rates of capacitance drain, magnetometer response, height, width, change in dimensions, etc., to generate a model for comparison to other readings. The model for copper piping can be stored in database of models for known objects (e.g., models for lead pipe, zinc pipe, aluminum studs, wooden studs, metal cross bracing, wooden cross bracing, copper wire, different gauges of wire, etc.).

Each model stored in the model database can include rates of change of capacitance drain induced at a capacitance sensor system, Gaussian image information, approximate image information, dimensions, contours, boundaries, specific features, and in some examples, can include a generated image mask configured for subsequent matching operations, among other data fields. Object models can also be associated with environment information, including, for example, a width of a concealing surface or an environment location in which the object is typically found during a capacitance capture event (e.g., housing construction, a security setting, and a luggage scanner).

Generated model data from 602 can be compared to known model data at 604. The model data selected for comparison can be limited by environmental information 606 (YES) to model data associated with a specific environment (e.g., at 608). Matches between model data can be determined at 610 to identify the concealed object as being the same as a known object. In some settings, environmental information is not provided 606 (NO). In such scenarios, all available model data can be accessed and compared to generate matches at 610.

As discussed, model data can include any one or more of: raw sensor data, correlated capacitance and location information, Gaussian image data, approximate image data, and derived properties for an object (height, width, length, contour, boundary, specific features, etc). In some implementations, image data for known models can include image masks derived from that information that enable matching between, for example, approximate image data and the known object masks. In other implementations, image masks can also be generated for Gaussian image data, allowing for identification of concealed objects from a Gaussian image.

For implementations where all available data is analyzed (e.g., 606 (NO)), processing capacity can be a consideration. In some embodiments, processing of model comparisons and matching model information (604-610) can be distributed across a plurality of computer systems. In further embodiments, one or more server systems can be employed to receive data from personal computing devices and perform the functions associated with model generation for received data and comparison to known models. Any resulting matches (e.g., at 610), can then be communicated back to the device.

Once a concealed object is identified, that information can be stored and associated with the data used to generate the identification. In some embodiments, identifications can be used to expand an object model database. In one embodiment, concealed objects that are identified can then be labeled in any display of the concealed object (e.g., Gaussian image, approximate image, etc.).

As discussed, process 600, among other processes and functions, can be executed on a variety of computer systems. The computer systems can include hand-held devices, and combinations of different computers system, including hand-held device connected to more robust server systems. FIG. 7 shows a block diagram of a distributed computer system 700, in which various aspects and functions in accord with the present invention may be practiced. The distributed computer system 700 may include one more computer systems. For example, as illustrated, the distributed computer system 700 includes three computer systems 702, 704 and 706. As shown, the computer systems 702, 704 and 706 are interconnected by, and may exchange data through, a communication network 708. The network 708 may include any communication network through which computer systems may exchange data. To exchange data via the network 708, the computer systems 702, 704, and 706 and the network 708 may use various methods, protocols and standards including, among others, token ring, Ethernet, Wireless Ethernet, Bluetooth, TCP/IP, UDP, HTTP, FTP, SNMP, SMS, MMS, SS7, JSON, XML, REST, SOAP, CORBA HOP, RMI, DCOM and Web Services.

Computer systems 702, 704 and 706 may include personal computing devices such as cellular telephones, smart phones, etc. The communication network may further employ one or more mobile access technologies including 2nd (2G), 3rd (3G), 4th (4G or LTE) generation radio access for cellular systems, WLAN, Wireless Router (WR) mesh, and other communication technologies. Access technologies such as 2G, 3G, 4G and LTE and future access networks may enable wide area coverage for mobile devices. For example, the network may enable a radio connection through a radio network access such as Global System for Mobile communication (GSM), General Packet Radio Services (GPRS), Enhanced Data GSM Environment (EDGE), Wideband Code Division Multiple Access (WCDMA), among other communication standards. Network may include any wireless communication mechanism by which information may travel between the devices 704 and other computing devices in the network.

Various aspects and functions in accord with the present invention may be implemented as specialized hardware or software executing in one or more computer systems including the computer system 702 shown in FIG. 7. In one embodiment, system 702 is a personal computing device specially configured to execute a processing engine. In another embodiment, system 702 is a personal computing device specifically configured to execute the functions discussed herein. According to one example, the personal computing device is a portable computer having a touch screen configured to be handheld and manipulated by hand over concealing surfaces.

As depicted, the computer system 702 includes a processor 710, a memory 712, a bus 714, an interface 716 and a storage system 718. The processor 710, which may include one or more microprocessors or other types of controllers, can perform a series of instructions that manipulate data. The processor 710 may be a well-known, commercially available processor such as an Intel Pentium, Intel Atom, ARM Processor, Motorola PowerPC, SGI MIPS, Sun UltraSPARC, or Hewlett-Packard PA-RISC processor, or may be any other type of processor or controller as many other processors and controllers are available. As shown, the processor 710 is connected to other system placements, including a memory 712, by the bus 714.

The memory 712 may be used for storing programs and data during operation of the computer system 702. Thus, the memory 712 may be a relatively high performance, volatile, random access memory such as a dynamic random access memory (DRAM) or static memory (SRAM). However, the memory 712 may include any device for storing data, such as a disk drive or other non-volatile storage device, such as flash memory or phase-change memory (PCM). Various embodiments in accord with the present invention can organize the memory 712 into particularized and, in some cases, unique structures to perform the aspects and functions disclosed herein.

Components of the computer system 702 may be coupled by an interconnection element such as the bus 714. The bus 714 may include one or more physical busses (for example, busses between components that are integrated within a same machine), and may include any communication coupling between system placements including specialized or standard computing bus technologies such as IDE, SCSI, PCI and InfiniB and. Thus, the bus 714 enables communications (for example, data and instructions) to be exchanged between system components of the computer system 702.

Computer system 702 also includes one or more interfaces 716 such as input devices, output devices and combination input/output devices. The interfaces 716 may receive input, provide output, or both. For example, output devices may render information for external presentation. Input devices may accept information from external sources. Examples of interface devices include, among others, keyboards, mouse devices, trackballs, microphones, touch screens, capacitance-based touch screens, capacitance sensor assemblies, printing devices, display screens, speakers, network interface cards, etc. The interface devices 716 allow the computer system 702 to exchange information and communicate with external entities, such as users and other systems.

Storage system 718 may include a computer-readable and computer-writeable nonvolatile storage medium in which instructions are stored that define a program to be executed by the processor. The storage system 718 also may include information that is recorded, on or in, the medium, and this information may be processed by the program. More specifically, the information may be stored in one or more data structures specifically configured to conserve storage space or increase data exchange performance. The instructions may be persistently stored as encoded signals, and the instructions may cause a processor to perform any of the functions described herein. A medium that can be used with various embodiments may include, for example, optical disk, magnetic disk or flash memory, among others. In operation, the processor 710 or some other controller may cause data to be read from the nonvolatile recording medium into another memory, such as the memory 712, that allows for faster access to the information by the processor 710 than does the storage medium included in the storage system 718. The memory may be located in the storage system 718 or in the memory 712. The processor 710 may manipulate the data within the memory 712, and then copy the data to the medium associated with the storage system 718 after processing is completed. A variety of components may manage data movement between the medium and the memory 712, and the invention is not limited thereto.

Further, the invention is not limited to a particular memory system or storage system. Although the computer system 702 is shown by way of example as one type of computer system upon which various aspects and functions in accord with the present invention may be practiced, aspects of the invention are not limited to being implemented on the computer system, shown in FIG. 7. Various aspects and functions in accord with the present invention may be practiced on one or more computers having different architectures or components than that shown in FIG. 7. For instance, the computer system 702 may include specially-programmed, special-purpose hardware, such as for example, an application-specific integrated circuit (ASIC) tailored to perform a particular operation disclosed herein. Another embodiment may perform the same function using several general-purpose computing devices running MAC OS System X with Motorola PowerPC processors and several specialized computing devices running proprietary hardware and operating systems.

The computer system 702 may include an operating system that manages at least a portion of the hardware placements included in computer system 702. A processor or controller, such as processor 710, may execute an operating system which may be, among others, a Windows-based operating system (for example, Windows NT, Windows 2000/ME, Windows XP, Windows 7, or Windows Vista) available from the Microsoft Corporation, a MAC OS System X operating system available from Apple Computer, one of many Linux-based operating system distributions (for example, the Enterprise Linux operating system available from Red Hat Inc.), a Solaris operating system available from Sun Microsystems, or a UNIX operating systems available from various sources. Many other operating systems may be used, and embodiments are not limited to any particular operating system.

The processor and operating system together define a computing platform for which application programs in high-level programming languages may be written. These component applications may be executable, intermediate (for example, C# or JAVA bytecode) or interpreted code which communicate over a communication network (for example, the Internet) using a communication protocol (for example, TCP/IP). Similarly, functions in accord with aspects of the present invention may be implemented using an object-oriented programming language, such as SmallTalk, JAVA, C++, Ada, or C# (C-Sharp). Other object-oriented programming languages may also be used. Alternatively, procedural, scripting, or logical programming languages may be used.

Additionally, various functions in accord with aspects of the present invention may be implemented in a non-programmed environment (for example, documents created in HTML, XML or other format that, when viewed in a window of a browser program, render aspects of a graphical-user interface or perform other functions). Further, various embodiments in accord with aspects of the present invention may be implemented as programmed or non-programmed placements, or any combination thereof. For example, a web page may be implemented using HTML while a data object called from within the web page may be written in C++. Thus, the invention is not limited to a specific programming language and any suitable programming language could also be used.

It is to be appreciated that embodiments of the methods and apparatuses discussed herein are not limited in application to the details of construction and the arrangement of components set forth in the following description or illustrated in the accompanying drawings. The methods and apparatuses are capable of implementation in other embodiments and of being practiced or of being carried out in various ways. Examples of specific implementations are provided herein for illustrative purposes only and are not intended to be limiting. In particular, acts, elements and features discussed in connection with any one or more embodiments are not intended to be excluded from a similar role in any other embodiments.

Also, the phraseology and terminology used herein is for the purpose of description and should not be regarded as limiting. Any references to embodiments or elements or acts of the systems and methods herein referred to in the singular may also embrace embodiments including a plurality of these elements, and any references in plural to any embodiment or element or act herein may also embrace embodiments including only a single element. References in the singular or plural form are not intended to limit the presently disclosed systems or methods, their components, acts, or elements. The use herein of “including,” “comprising,” “having,” “containing,” “involving,” and variations thereof is meant to encompass the items listed thereafter and equivalents thereof as well as additional items. References to “or” may be construed as inclusive so that any terms described using “or” may indicate any of a single, more than one, and all of the described terms. Any references to front and back, left and right, top and bottom, upper and lower, and vertical and horizontal are intended for convenience of description, not to limit the present systems and methods or their components to any one positional or spatial orientation.

Having thus described several aspects of at least one embodiment of this invention, it is to be appreciated that various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

What is claimed is:

1. A system for detecting concealed objects, the system comprising:
at least one capacitance sensor integrated in a hand-held computing device;
at least one processor configured to:
access location information for the hand-held computing device, and
correlate capacitance data received from the at least one capacitance sensor with the location information; and
a display configured to render an image representing a concealed object from the correlated capacitance data and location information.

2. The system according to claim 1, further comprising at least one location sensor in the hand-held computing device.

3. The system according to claim 2, wherein the at least one processor is further configured to generate the location information for the hand-held computing device responsive to sensor data received from the at least one location sensor.

4. The system according to claim 3, wherein the at least one location sensor includes at least one accelerometer, and the at least one processor is further configured to generate the location information from measurements of acceleration by the at least one accelerometer of the hand-held computing device.

5. The system according to claim 1, wherein the at least one processor is further configured to generate the location information from a predefined path of travel for the hand-held computing device.

6. The system according to claim 1, wherein the at least one processor is further configured to generate image data for the concealed object from correlating the capacitance data and the location information.

7. The system according to claim 6, wherein the at least one processor is further configured to execute an integral operation on the image data to transform the image data from a derivative format to an approximate image format of the concealed object.

8. The system according to claim 1, wherein the at least one processor is further configured to identify concealed objects detected with the correlated capacitance data and location information.

9. The system according to claim 8, wherein the at least one processor is further configured to compare the correlated capacitance data and the location information to known models of concealed objects to identify concealed objects.

10. The system according to claim 1, wherein the at least one processor is further configured to:
determine subsequent location information for the hand-held device; and
select a portion of an image of the concealed object to display, responsive to the subsequent location.

11. A computer implemented method for detecting concealed objects, the method comprising acts of:
positioning at least one capacitance sensor of a computing device on a concealing surface;
capturing, by at least one processor, capacitance data from the at least one sensor while transitioning the computing device across the concealing surface; and
generating, by the at least one processor, image data associated with a concealed object from the capacitance data and location information for the computing device.

12. The method according to claim 11, further comprising an act of capturing, by the at least one processor, location information from at least one location sensor in the computing device.

13. The method according to claim 12, wherein the method further comprising an act of generating, by the at least one processor, the location information for the computing device responsive to the act of capturing the location information from the at least one sensor.

14. The method according to claim 13, wherein the at least one location sensor includes at least one accelerometer, and wherein the act of generating the location information includes an act of generating location information from measurements of acceleration by the at least one accelerometer.

15. The method according to claim 11, further comprising an act of generating, by the at least one processor, the location information from a predefined path of travel for the computing device.

16. The method according to claim 11, wherein the act of generating, by the at least one processor, image data associated with a concealed object includes an act of correlating the capacitance data and the location information.

17. The method according to claim 16, further comprising an act of transforming, by the at least one processor, the image data from a derivative image format to an approximate image format of the concealed object.

18. The method according to claim 11, further comprising an act of identifying, by the at least one processor, concealed objects based, at least in part, on the correlated capacitance data and location information.

19. The method according to claim 18, wherein the act of identifying includes an act of comparing the correlated capacitance data and the location information to known models of concealed objects.

20. The method according to claim 11, further comprising acts of:
determining subsequent location information for the device; and
selecting a portion of an image of the concealed object to display, responsive to the subsequent location.
